(19) United States
(12) Patent Application Publication
(10) Pub. No.: US 2025/0377887 A1
(43) Pub. Date: Dec. 11, 2025

(54) INTEGRATED CLIENT-SIDE AND SERVER-SIDE APPLICATION DEVELOPMENT

(71) Applicant: Niantic Spatial, Inc., San Francisco, CA (US)

(72) Inventors: Erik Marshall Murphy-Chutorian, Palo Alto, CA (US); Nicholas John Butko, Cupertino, CA (US); Rigel Gareth Benton, Mountain View, CA (US); Christoph Michael Bartschat, Mountain View, CA (US); Kyle Thach Truong, Santa Clara, CA (US)

(21) Appl. No.: 19/234,206

(22) Filed: Jun. 10, 2025

Related U.S. Application Data
(60) Provisional application No. 63/658,860, filed on Jun. 11, 2024.

(51) Int. Cl. G06F 8/71; G06F 9/50

(52) U.S. Cl. CPC G06F 8/71; G06F 9/5027

(57) ABSTRACT

A system may provision an application-specific cloud account for a backend component of a software application. The system may receive a request from a client system executing a client side component of the software application, the request including authorization credentials and a version identifier for the backend component. The system may validate the authorization credentials to determine the client system is authorized to access the requested virtual reality content. The system may identify a backend version of the backend component associated with the version identifier in the request. The system may load, into the cloud account, the backend component corresponding to the identified backend version. The system may execute the loaded backend component to process the request and generate the requested virtual reality content. The system may return the requested virtual reality content to the client system.

### CROSS-REFERENCE TO RELATED APPLICATION

This application claims priority to, and the benefit of, U.S. Provisional Patent Application Ser. No. 63/658,860, “Integrated Client-Side/Server-Side Application Development,” filed on Jun. 11, 2024, which is incorporated herein by reference in its entirety.

### BACKGROUND

### Technical Field

The present disclosure relates to the field of software development, and more specifically to integrated client-side and server-side application development and deployment.

### Description of Related Art

Software engineers may develop software applications that have a component that executes on a client device and another component that executes on a remote server. These client-side and server-side components interact with each other over a network and require common communication protocols or interfaces to interact correctly. However, when developers update one or the other of these components, the communication between these components can break down and cause errors. For example, a developer may push a new version of a server-side component with a new API that is incompatible with versions of the client-side component that uses an old API. Thus, client devices that have yet to update their client-side component can have performance issues if they try to interface with the new server-side component. Therefore, software engineers must make a significant effort to avoid these problems when updating applications that they are working on.

### BRIEF DESCRIPTION OF THE DRAWINGS

Embodiments of the disclosure have other advantages and features which will be more readily apparent from the following detailed description and the appended claims, when taken in conjunction with the examples in the accompanying drawings, in which:

FIG. 1 illustrates an example system environment for an integrated development system, in accordance with some embodiments.

FIG. 2 is a block diagram of integrated development system, according to one or more embodiments.

FIG. 3 is a block diagram of cloud server system, according to one or more embodiments.

FIG. 4 is a diagram illustrating requests from different client-side component versions being routed to different versions of the back end component.

FIG. 5 is an interaction diagram for an example process of distributing an updated version of an application through an integrated development system, in accordance with some embodiments.

FIG. 6 is an interaction diagram for an example process of how an end-user client application uses a client application developed through an integrated development system, in accordance with some embodiments.

FIG. 7 is a flowchart illustrating a method, according to one or more embodiments.

FIG. 8 is a block diagram illustrating components of an example machine able to read instructions from a machine-readable medium and execute them in a processor (or controller).

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

### Configuration Overview

Some embodiments relate to a system that utilizes a modular architecture within a cloud environment to dynamically process client-side requests based on their specific requirements and contexts. The system can incorporate a validation module that acts as an API gateway to evaluate and route requests to corresponding versions of backend components, which are loaded on-demand into an isolated cloud account associated with the application. This allows backend components (and their component packages) to operate independently within secure accounts, preventing interaction with other backend instances. An execution module subsequently processes the validated and routed requests by executing backend functions, such as data processing or API interactions. This approach enhances operational security compared to conventional systems by only loading and executing requisite components in response to specific requests and in isolated server accounts.

Other aspects include components, devices, systems, improvements, methods, processes, applications, (e.g., non-transitory) computer readable mediums, and other technologies related to any of the above.

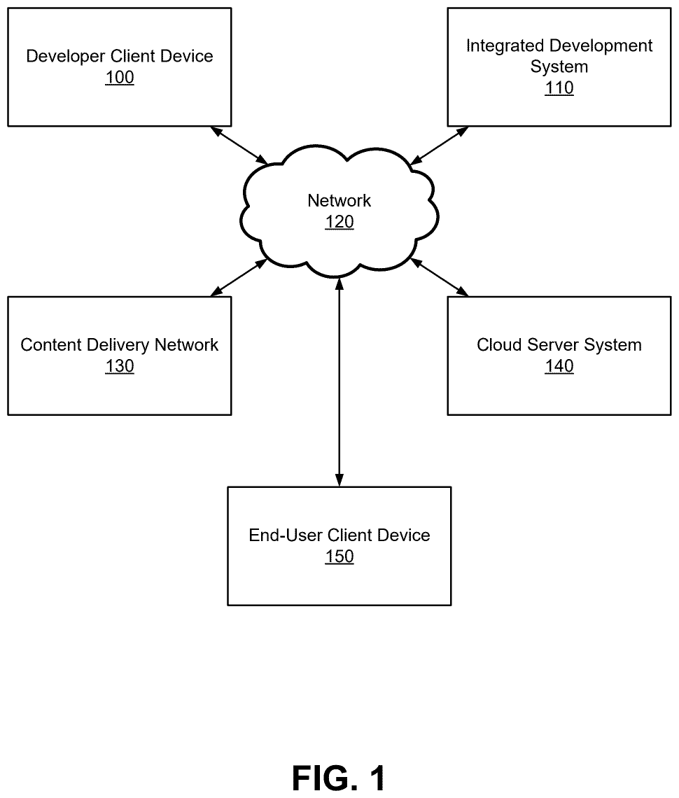

An integrated development system improves the development and deployment of (e.g., virtual reality) software applications by offering tools and user interfaces to developers of these applications. FIG. 1 illustrates an example system environment for an integrated development system 110, in accordance with some embodiments. The system environment illustrated in FIG. 1 includes integrated development system 110, cloud server system 140, end-user client device 150, content delivery network 130, and developer client device. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

A user can interact with other systems through a client device, such as developer client device 100 or end-user client device 150. A client device can be a personal or mobile computing device, such as a smartphone, a tablet, a laptop computer, or desktop computer. In some embodiments, a client device executes a client-side application component that uses an application programming interface (API) to communicate with other systems through the network 120.

In the context of FIG. 1, developer client device 100 is a client device used by a user to interact with integrated development system 110 to develop a software application with a component that executes on end-user client device 150 and another component that executes on cloud server system 140. Although the example of FIG. 1 only includes a single developer client device 100 and a single end-user client device 150, the system environment may include multiple client devices e.g., many different end-user client devices 150 execute many applications previously developed via developer client devices 100 interacting with integrated development system 110.

The network 120 is a collection of computing devices that communicate via wired or wireless connections. The network 120 may include one or more local area networks (LANs) or one or more wide area networks (WANs). The network 120, as referred to herein, is an inclusive term that may refer to any or all of standard layers used to describe a physical or virtual network, such as the physical layer, the data link layer, the network layer, the transport layer, the session layer, the presentation layer, and the application layer. The network 120 may include physical media for communicating data from one computing device to another computing device, such as MPLS lines, fiber optic cables, cellular connections (e.g., 3G, 4G, or 5G spectra), or satellites. The network 120 also may use networking protocols, such as TCP/IP, HTTP, SSH, SMS, or FTP, to transmit data between computing devices. In some embodiments, the network 120 may include Bluetooth or near-field communication (NFC) technologies or protocols for local communications between computing devices. Similarly, the network 120 may use phone lines for communications. The network 120 may transmit encrypted or unencrypted data.

Content delivery network 130 is a network that receives client-side application components from integrated development system 110, stores those components, and delivers those components to end-user client devices (e.g., 150), for example, after a new application is developed or the client-side component is updated by integrated development system 110

Cloud server system 140 may be a third-party system or may be part of the integrated development system 110. For a given application (e.g., developed by integrated development system 110) with a server-side component (also referred to as a “backend component”), cloud server system 140 may provision a fixed set of server resources for the server-side component or may employ a serverless architecture and simply manage which server resources to allocate to the server-side component dynamically based on resource usage.

The integrated development system 110 may transmit a server-side component to cloud server system 140 for storage and execution. Upon receiving the server-side component, cloud server system 140 may load the server-side component on the server resources of the cloud server system 140. While being loaded, the server-side component waits for requests from client-side components operating on end-user client devices and services requests when they arrive. In some embodiments, cloud server system 140 waits for requests from client-side components before loading the server-side component.

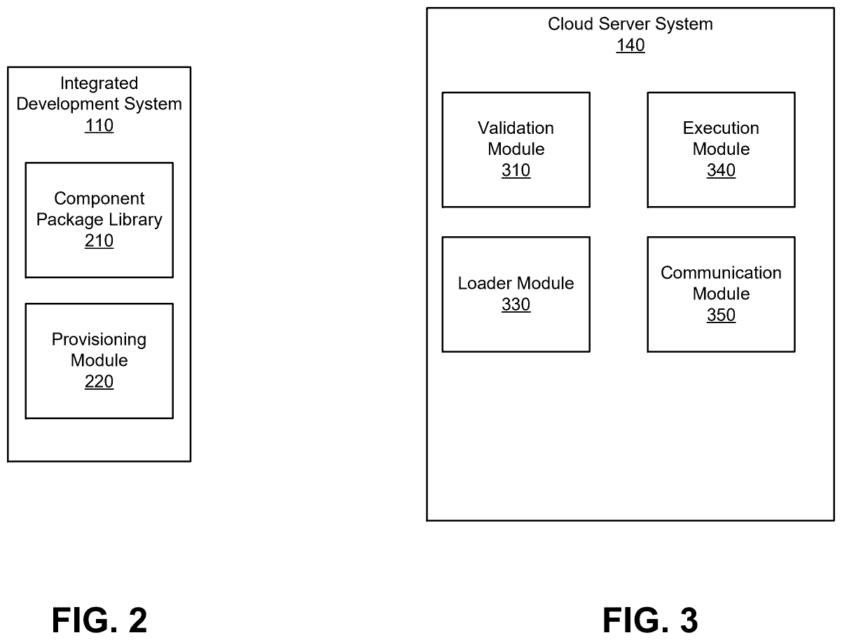

FIG. 2 is a block diagram of integrated development system 110, according to one or more embodiments. Integrated development system 110 in FIG. 2 includes component package library 210 and provisioning module 220. Alternative embodiments of FIG. 2 may include more, fewer, or different components from those illustrated, and the functionality of each component may be divided between the components differently from the description below.

Provisioning module 220 can (e.g., automatically) provision isolated cloud accounts on cloud server system 140 for developers or individual applications (e.g., backend components of applications). Provisioning a cloud account may include allocating computing resources for use by a user or application associated with the cloud account or may include establishing credentials or processes for a user or application associated with the cloud account to request or be assigned resources. Provisioning module 220 may provision a new cloud account when a new developer or application is initiated (in some embodiments, a single developer has the same account for multiple applications). Thus, for example, each project operates within its own sandboxed environment. Such isolation enhances security and simplifies troubleshooting by confining potential issues to a single environment. For example, separate accounts reduces the risk of a developer or application accessing information (e.g., sensitive data) or code of a separate developer or application (since those are stored in separate accounts on cloud server system 140).

Component package library 210 is a library of component packages. A component package is a self-contained reusable code asset (e.g., a function) or library that developers can create and share within integrated development system 110. Component packages can encapsulate both client-side logic and backend functionality (e.g., a backend function). A component of an application (e.g., a backend component) may utilize multiple component packages. The modular design promotes code reusability and simplifies the development process by enabling developers to leverage existing functionalities without having to rewrite code from scratch. Developers can import and use component packages when developing their own applications.

A component package may include a version management system. If a developer generates an update for a component package, a new version of that component package with the corresponding update may be generated. Applications that uses the component package may or may not automatically receive the updated version of the component package. An application can be pinned to a specific version of the component package, can receive the update if it relates to a bug fix, can receive the update if it relates to a new feature, can receive the update if it relates to a major release, or any combination thereof. The degree of update that an application receives may be based on a predetermined update setting of the application (e.g., set by the user who developed the application).

Among other advantages, the version management system enables a customizable update strategy for an application. For example, an application remains stable by remaining pinned to a specific version of a component package (e.g., to prevent unexpected changes that may disrupt the functionality of the application). In this situation, the application would continue to use an older version of the component package even if later versions of the component package are generated or exist. However, in another example, an application is enabled to receive selective updates (e.g., for critical bug fixes) while opting out of larger updates that may introduce substantial changes or disrupt dependencies. In some embodiments, updates are not propagated for component packages with backend functions. More specifically, if an application uses a component package with a backend function, then the application may remain pinned to a specific version of that component package, thus helping ensure that backend functionalities are not disturbed by updates to component packages.

A backend function is a server-side operation (also “backend operation”) that runs in response to requests from a client side component of an application (e.g., executed by end-user client device 150). A backend function may be handled or implemented by a component package. A backend function may run in a serverless environment, such as LAMBDA of AMAZON WEB SERVICES. Back end functions can handle various tasks such as processing data, interacting with databases, or external communications via APIs. A backend function may be executed only when needed (e.g., in response to a request from a client device e.g., 150). As previously described, a backend function may securely manage sensitive information, such as API keys, through environment variables, to help ensure that these secrets are not exposed in the application code.

In some embodiments, a component package includes an environmental variable to be used to execute the component package. For example, the environmental variable is an API key that enables the component packages backend function to perform an API call to an external application (e.g., a third party application), such as a Large Language Model (LLM). For example, when an application executes a backend function of a component package, that backend function uses a unique API key (e.g., previously supplied by the application developer). An environmental variable may not be released or published outside of the component package. Thus, environmental variables enable applications to use component packages to perform operations without exposing sensitive information (e.g., an API key) in the application code related to those operations.

FIG. 3 is a block diagram of cloud server system 140, according to one or more embodiments. Cloud server system 140 of FIG. 3 includes validation module 310, loader module 330, execution module 340, and communication module 350. Alternative embodiments of FIG. 3 may include more, fewer, or different components from those illustrated, and the functionality of each component may be divided between the components differently from the description below.

Communication module 350 receives requests for data (e.g., virtual reality content) from a client-side component of an application (e.g., executed by end-user client device 150). A request may include authorization credentials and a version identifier. The authorization credentials include information used to verify the request and permissions of the client-side component. The version identifier identifies which version of the backend component the request should be received by. In other words, the version identifier identifies which version of the backend component that corresponds to the client-side component. In some embodiments, the version identifier includes version identifiers for component packages used by the backend component. Communication module 350 provides the request (or content of the request) to validation module 310 and/or loader module 330 (e.g., after the request is validated by validation module 310). Communication module 350 also receives data requested from the client side component from execution module 340 and transmits the requested data to the client side component.

Validation module 310 receives a request from communication module 350 and validates the request. Validation module 310 helps ensure the integrity and security of requests received by cloud server system 140. For example, upon receiving a request from communication module 350, it analyzes the request to confirm that it adheres to predefined protocols and requirements. This may include verifying the source of the request, checking for proper authentication credentials, and confirming the request structure conforms to expected formats. Additionally, or alternatively, validation module 310 may assess whether the requested operation is authorized based on permissions or policies associated with the user or the application. By performing these checks, the validation module 310 helps act as a safeguard, preventing invalid or malicious requests from proceeding further into the system e.g., particularly in scenarios that involve sensitive data or external API interactions.

In some embodiments, validation module 310 is an API gateway that proxys requests through to the correct version of the backend component (e.g., after the backend component is already loaded). An API gateway serves as an intermediary between client-side application components and backend application components, acting as a centralized entry point for managing requests (e.g., API calls). It may handle various tasks such as routing API calls to appropriate backend components, transforming requests and responses, and enforcing API usage policies. Generally, the API gateway processes incoming requests from client devices, determines which service or component within the backend should handle the request, and then forwards the request accordingly. The gateway may perform additional operations, such as aggregating data from multiple backend services to respond to a single client request or modifying request headers and payloads to meet backend service requirements. API gateways also perform protocol translation, allowing clients using one communication protocol (e.g., HTTP) to interact with services using a different protocol.

As previously mentioned, in some embodiments, cloud server system 140 employs a serverless architecture. Serverless backend implementation may refer to the use of cloud-based services to execute backend operations (e.g., backend functions) without the need to manage underlying server infrastructure. This approach dynamically scales resources based on the volume of incoming requests, providing flexibility and cost efficiency. For example, backend functions are loaded and executed only in response to specific client-side requests, which means they operate on-demand rather than running continuously, reducing idle costs.

If a backend application component associated with the request is not loaded, loader module 330 can load the backend component into an isolated account of cloud server system 140 (e.g., associated with the application). Loader module 330 may load the backend component responsive to the request (e.g., after the request is validated by validation module 310) into the appropriate account of the cloud server system 140. The loading may be in response to receiving or validation of a request for a backend functionality from a client-side application component. Loading may include loading one or more component packages of the server-side component of the application into the account (of the cloud server system 140), as opposed to being stored or loaded into another account of cloud server system 140. Thus, even though multiple applications may use a given component package, each application may only interact with the instance of the component package loaded into its own account on the cloud server system 140. Among other advantages, loading a component package into an individual account increases security by containing a component package (and its associated functionalities) within a single account of the cloud server system 140.

Loader module 330 can analyze the request to determine which version of a backend component should be loaded (if there are multiple versions of the backend component). This may also include determining which component packages (and versions of those component packages) are used by that version of the backend component, since each backend component may use different component packages or different versions of a given set of component packages. Thus, the appropriate version of the backend component package can be loaded into the account. Among other advantages, this enables the client-side component to interact with the version of the backend component (and the versions of the corresponding component packages) that the application was created to interact with instead of being forced to interact with the latest version of the backend component (or the latest version of the component packages). For example, this may be advantageous if different versions of a backend component use different API protocols. In this example, it's important for the appropriate version of the backend component to be loaded. Otherwise, the client-side component may be unable to communicate with the backend component. In some embodiments, when a backend component is being loaded, all component packages of that backend component are also loaded. However, in some other embodiments, only component packages used to respond to a given request are loaded.

Execution module 340 is a component of the cloud server system 140 that runs backend operations in response to requests from client-side components (e.g., after the backend component is loaded by loader module 330). Execution module 340 executes tasks specified by the request or to fulfill the request. These tasks may include data processing, database interactions, or facilitating external communications through APIs. For example, execution module 340 executes one or more backend functions of component packages.

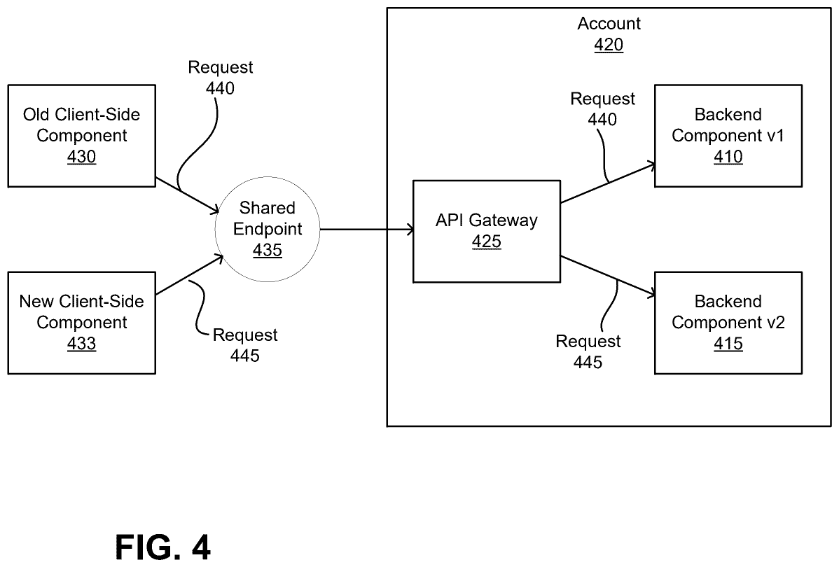

FIG. 4 is a diagram illustrating requests from different client-side component versions being routed to different versions of the back end component. More specifically, a request 440 from an older version client-side component (labeled “old client-side component 430”) is transmitted to API gateway 425 via shared endpoint 435. API gateway 425 then transmits the request 440 to a first version of a backend component (labeled “backend component v1 410”) in an account 420 of cloud server system 140. Additionally, a request 445 from a newer version client-side component (labeled “new client-side component 433”) is transmitted to API gateway 425 via shared endpoint 435. API gateway 425 then transmits the request 445 to a second version of the backend component (labeled “backend component v2 415”) in account 420. Thus, version skew is avoided by client-side components submitting requests that are received by corresponding versions of the backend component which the application was built with.

Note that the client-side components (430, 433) are being executed by different client devices 150. API gateway 425 routes the requests to the appropriate backend components. API gateway 425 may be part of validation module 310. Additionally, both backend components (410 and 415) may have been loaded by loader module 330 (e.g., responsive to requests.

In some embodiments, integrated development system 110 can perform rollback. Rollback is the process of reverting a backend application component a previously deployed version in cases where a new update introduces issues, using previously built backend code stored securely to match the associated client-side application component. This allows developers to quickly address user concerns and restore functionality without excessive troubleshooting.

Integrated development system 110 may perform content hashing. Content hashing is a method of generating a unique hash value based on the specific content of a backend component (e.g., code file or module), often using a cryptographic hash functions to analyze the file's binary or textual content. The hash value is computed by passing the content through the hash function, which produces a fixed-length string that serves as a unique identifier for that particular version of the backend component. This approach allows the system 110 to identify duplicate or unchanged backend components efficiently, reducing redundant deployments and saving computational resources.

### Use of Version Management Information

In some embodiments, integrated development system 110 allows for an improved process for developing applications with client-side and server-side components by coordinating the deployment of new versions of the client-and server-side components through other systems. Specifically, when the integrated development system receives a new version of the application from a developer client device, the integrated development system may transmit the client-side component to a content delivery network for distribution to end-user client devices. The integrated development system also transmits the server-side component to a cloud server system to perform the backend functionalities of the server-side component.

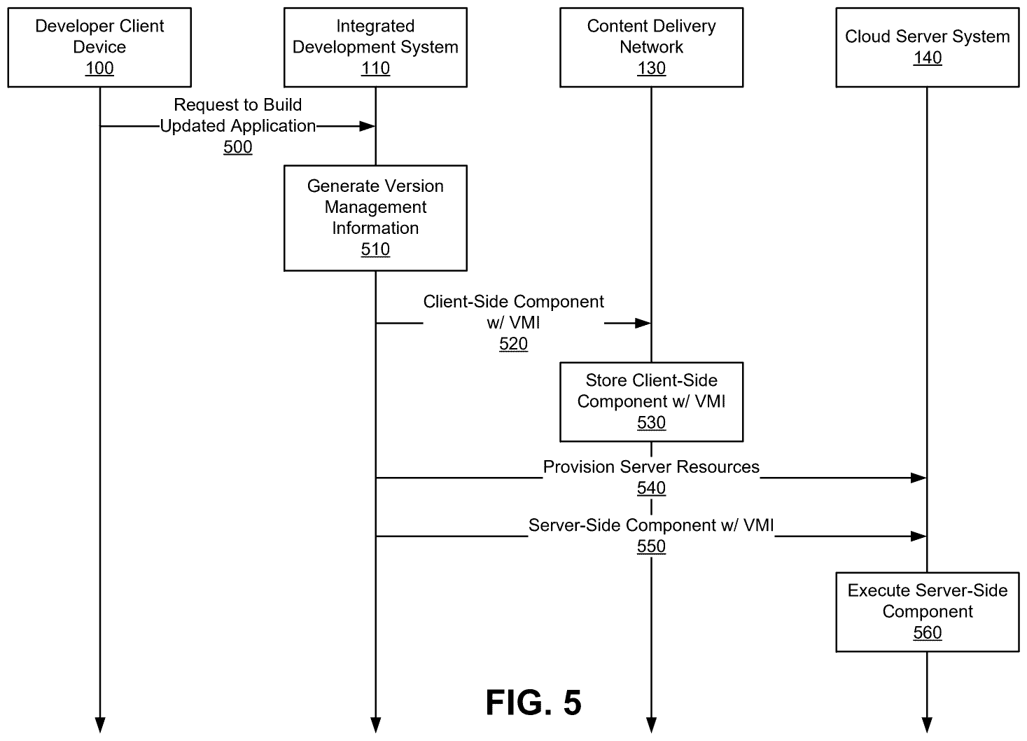

FIG. 5 is an interaction diagram for an example process of distributing an updated version of an application through an integrated development system, in accordance with some embodiments. Alternative embodiments may include more, fewer, or different steps or devices performing those steps. Similarly, the steps may be performed in an order different from that illustrated in FIG. 5 or may be divided among the devices differently from the embodiment illustrated in FIG. 5.

A developer client device 100 transmits a request 500 to the integrated development system 110 to build an updated application. The request may include source code that a developer has written for the application.

The application includes a client-side component and a server-side component. The client-side component is a software program that executes on an end user's client device and allows the end user to interface with the server-side component. For example, the client-side component may be a web site executed in a web browser or a client application installed on the end user's client device. The server-side component is a software program that executes on a remote server and provides backend functionalities for the client-side component. For example, the server-side component may receive, process, store, and transmit data for the client-side component. The client-side component and the server-side component may communicate through an application programming interface (API).

When the integrated development system 110 receives the request 500 to build the updated application, the integrated development system 110 generates 510 version management information 510 for the received updated application. The version management information 510 identifies the updated application as a new version of the application and specifies which version the updated application corresponds to. In some embodiments, the integrated development system embeds version management information in the client-side and server-side components of the application.

The integrated development system 110 transmits the client-side component 520 to a content delivery network 130 for storage and delivery to end-user client devices. The integrated development system 110 transmits the client-side component 520 with the version management information generated for it by the integrated development system 110. The content delivery network 130 stores 530 the client-side component with the version management information.

The integrated development system 110 also transmits a request 540 to provision server resources at a cloud server system 140. The cloud server system 140 may be a third-party system or may be part of the integrated development system. The cloud server system 140 may provision a fixed set of server resources for the server-side component or may employ a serverless architecture and simply manage which server resources to allocate to the server-side component dynamically based on resource usage.

The integrated development system 110 transmits the server-side component 550 to the cloud server system 140 for storage and execution. The integrated development system 110 includes the version management information that it generated for the server-side component with that component. Upon receiving the server-side component, the cloud server system 140 executes 560 the server-side component on the server resources of the cloud server system 140. While being executed, the server-side component waits for requests from client-side components operating on end-user client devices and services requests when they arrive.

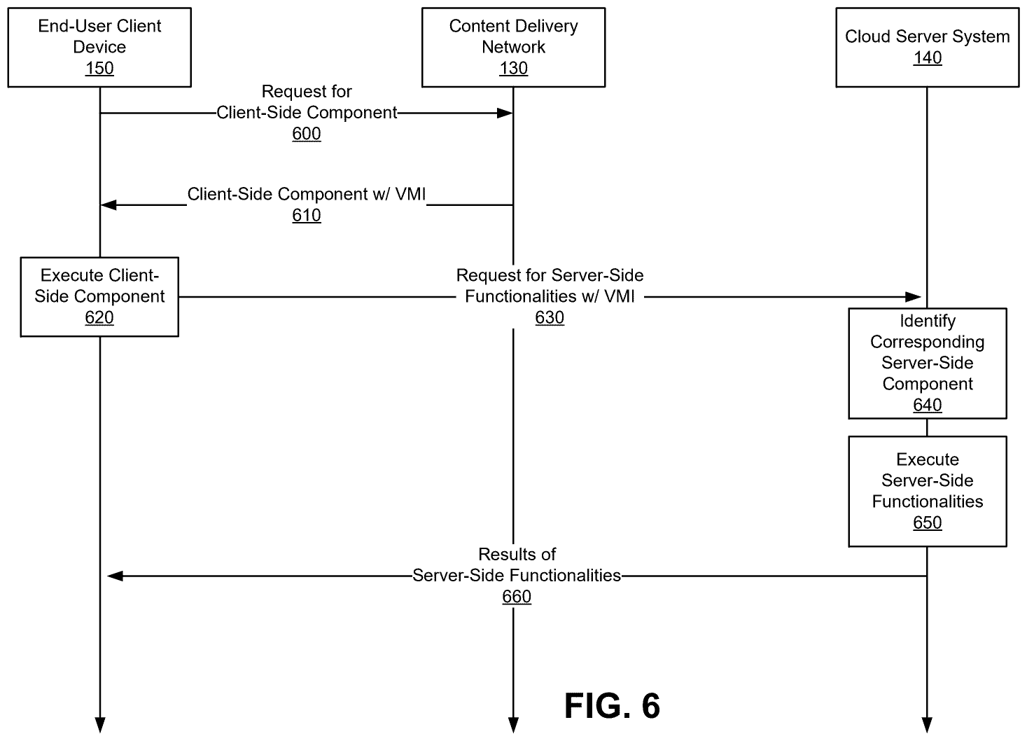

FIG. 6 is an interaction diagram for an example process of how an end-user client application uses a client application developed through an integrated development system, in accordance with some embodiments. Alternative embodiments may include more, fewer, or different steps or devices performing those steps. Similarly, the steps may be performed in an order different from that illustrated in FIG. 6 or may be divided among the devices differently from the embodiment illustrated in FIG. 6.

An end-user client device 150 transmits a request 600 to a content delivery network 130 for a client-side component of an application. The content delivery network delivers the client-side component 610 to the end-user client device 150 for execution. The content delivery network 130 delivers the client-side component with the version management information that was generated for it by the integrated development system. The end-user client device 150 executes 620 the client-side component, which transmits a request 630 to the cloud server system 140 for the server-side component to perform server-side functionalities for the client-side component. The request includes version management information generated by the integrated development system.

The cloud server system 140 may store different server-side components for different applications and may store different versions of a server-side component for the same application. The cloud server system uses the version management information in the request 630 to identify 640 a server-side component that corresponds to the client-side component that transmitted the request 630. The cloud server system uses the server-side component associated with the received version management information to execute 650 the server-side functionalities requested by the client-side component. The cloud server system transmits the results 660 of the server-side functionalities to the client-side component.

In some embodiments, the cloud server system makes the server-side component available to end-user client devices through a uniform resource locator (URL). Specifically, the client-side component may use a URL to identify and access server-side functionalities of the server-side component. When the client-side component uses the URL to access the server-side functionalities, the request may include credentials that verify that the server-side functionalities are being called by a client-side component that should be calling the server-side functionalities of the server-side component. In other words, the server-side component verifies the credentials received with the request including the URL to verify that the request is not coming from a client-side component of the wrong version or that the request is not coming from a malicious actor trying to access the server-side functionalities.

### Example Methods

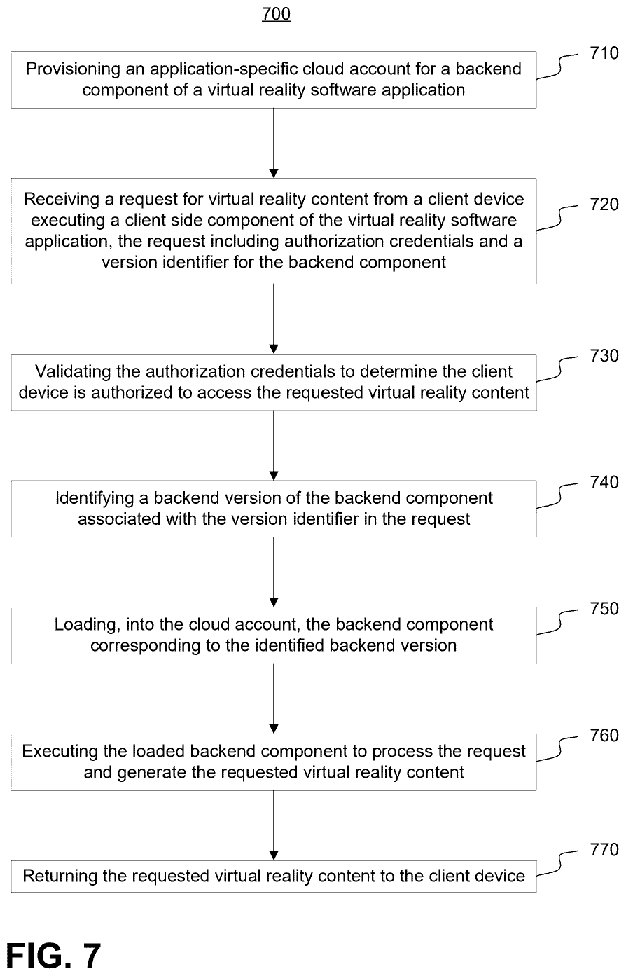

FIG. 7 is a flowchart illustrating a method 700, according to one or more embodiments. In the example of FIG. 7, integrated development system 110 and cloud server system 140 are a single entity (e.g., integrated development system 110 operates on cloud server system 140), and the method 700 is from the perspective of the single entity. However, this is not required. For example, integrated development system 110 and 140 are separate entities and all steps of method 700 are performed by either integrated development system 110 or cloud server system 140. As previously mentioned, integrated development system 110 or cloud server system 140 may be a third-part system. The steps of the method 700 may be performed in different orders, and the method 700 may include different, additional, or fewer steps.

At step 710, provisioning module 220 provisions an (e.g., application-specific) cloud account for a backend component of a (e.g., virtual reality) software application. In some other embodiments, integrated development system 110 provisions the account (e.g., via provisioning module 220) or cloud server system 140 provisions the account itself.

At step 720, communication module 350 receives a request for (e.g., virtual reality) content from a client device (e.g., 150) executing a client side component of the software application, the request including authorization credentials and a version identifier for the backend component.

At step 730, validation module 310 validates the authorization credentials to determine the client side component or the client device is authorized to access the requested content.

At step 740, loader module 330 identifies a backend version of the backend component associated with the version identifier in the request.

At step 750, loader module 330 loads, into the cloud account, the backend component corresponding to the identified backend version.

At step 760, execution module 340 executes the loaded backend component to process the request and generate the requested content.

At step 770, communication module 350 returns the requested content to the client device.

In some aspects, the version identifier for the backend component is a component package version identifier for a component package of the backend component. The component package is a portion of the backend component and the backend component may include multiple component packages.

In some aspects, identifying the backend version of the backend component associated with the version identifier includes identifying a version for the component package of the backend component based on the component package version identifier.

In some aspects, loading the backend component includes loading the component package corresponding to the identified component package version, the component package corresponding to the identified component package version including a backend function.

In some aspects, executing the loaded backend component includes executing the backend function.

In some aspects, the backend version is not the latest backend version of the backend component.

In some aspects, the method further includes: receiving a second request for second (e.g., virtual reality) content from a second client device (e.g., 150) executing the client side component of the software application, the request including a second version identifier for the backend component; identifying a second backend version of the backend component associated with the second version identifier in the request, where the second backend version is different than the backend version; loading, into the cloud account, the backend component corresponding to the second backend version in a serverless environment, where the backend component corresponding to the identified second backend version is different than the backend component corresponding to the identified backend version; executing the backend component corresponding to the second backend version to process the second request and generate the second requested content; and returning the second requested content to the second client device.

In some aspects, the backend component is loaded in a serverless environment.

In some aspects, each backend version of the backend component has a different application programming interface (API) protocol.

Other aspects include components, devices, systems, improvements, methods, processes, applications, (e.g., non-transitory) computer readable mediums, and other technologies related to any of the above.

### Example Computing System

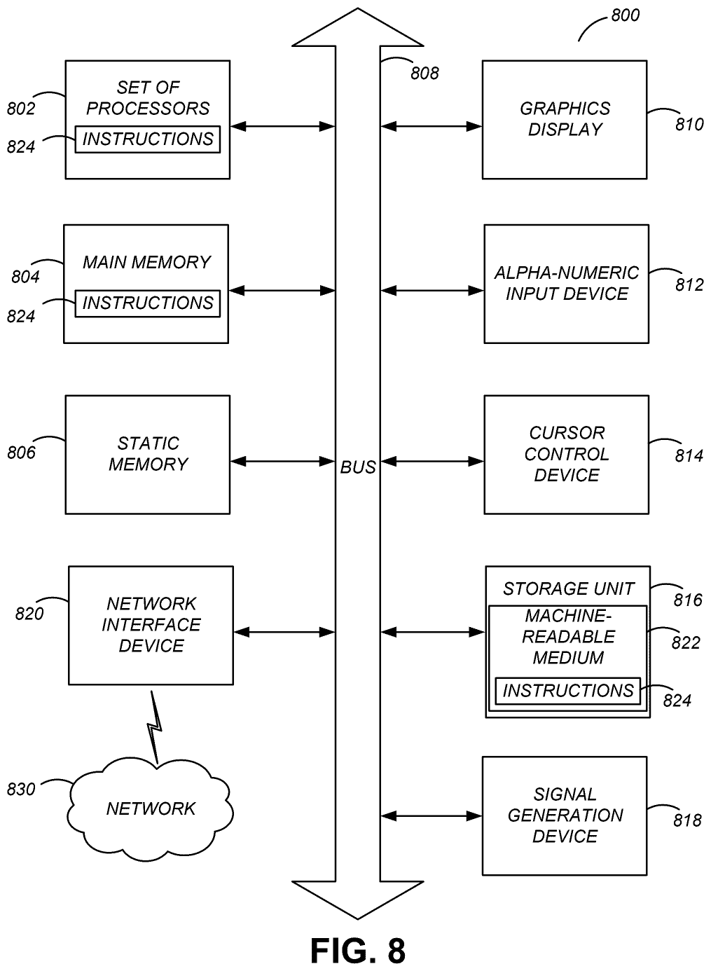

FIG. 8 is a block diagram illustrating components of an example machine able to read instructions from a machine-readable medium and execute them in a processor (or controller). Specifically, FIG. 8 shows a diagrammatic representation of a machine in the example form of a computer system 800. The computer system 800 can be used to execute instructions 824 (e.g., program code or software) for causing the machine to perform any of the methodologies (or processes) described herein. The machine may operate as a standalone device or provide the described functionality in conjunction with other connected (e.g., networked) devices. The machine may operate in the capacity of a server or a client in a server-client network environment, or as a peer machine in a peer-to-peer (or distributed) network environment.

The machine may be a server computer, a client computer, a personal computer (PC), a tablet PC, a smartphone, a network router, or any other machine capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes a set of one or more processing units (generally set of one or more processors 802). The set of one or more processors 802 is, for example, one or more central processing units (CPUs), one or more graphics processing unit (GPUs), one or more digital signal processors (DSPs), one or more controllers, one or more state machines, one or more application specific integrated circuits (ASICs), one or more radio-frequency integrated circuits (RFICs), or any combination of these. Any reference herein to a processor 802 may refer to a single processor or multiple processors. If the set of processors 802 includes multiple processors, the processors may perform operations individually or collectively. The computer system 800 also includes a main memory 804. The computer system may include a storage unit 816. The processor 802, memory 804, and the storage unit 816 communicate via a bus 808.

In addition, the computer system 800 can include a static memory 806, a display driver 810 (e.g., to drive a plasma display panel (PDP), a liquid crystal display (LCD), or a projector). The computer system 800 may also include alphanumeric input device 812 (e.g., a keyboard), a cursor control device 814 (e.g., a mouse, a trackball, a joystick, a motion sensor, a touchscreen, or other pointing instrument), a signal generation device 818 (e.g., a speaker), and a network interface device 820, which also are configured to communicate via the bus 808. The computer system 800 may also include other input devices/sensors, such as a microphone, camera, barometer, gyroscope, accelerometer, etc.

The storage unit 816 includes a machine-readable medium 822 on which is stored instructions 824 (e.g., software) embodying any one or more of the methodologies or functions described herein. The instructions 824 may also reside, completely or at least partially, within the main memory 804 or within the processor 802 (e.g., within a processor's cache memory) during execution thereof by the computer system 800, the main memory 804 and the processor 802 also constituting machine-readable media. The instructions 824 may be transmitted or received over a network 830 via the network interface device 820.

While machine-readable medium 822 is shown in an example embodiment to be a single medium, the term “machine-readable medium” should be taken to include a single medium or multiple media (e.g., a centralized or distributed database, or associated caches and servers) able to store the instructions 824. The term “machine-readable medium” shall also be taken to include any medium that is capable of storing instructions 824 for execution by the machine and that cause the machine to perform any one or more of the methodologies disclosed herein. The term “machine-readable medium” includes, but not be limited to, data repositories in the form of solid-state memories, optical media, and magnetic media.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non transitory, tangible computer readable storage medium and may include any embodiment of a computer program product or other data combination described herein.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the element or component is present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs that may be used to employ the described techniques and approaches. Thus, while particular embodiments and applications have been illustrated and described, it is to be understood that the described subject matter is not limited to the precise construction and components disclosed. The scope of protection should be limited only by the following claims.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
provisioning an application-specific cloud account for a backend component of a virtual reality software application;
receiving a request for virtual reality content from a client device executing a client side component of the virtual reality software application, the request including authorization credentials and a version identifier for the backend component;
validating the authorization credentials to determine the client device is authorized to access the requested virtual reality content;
identifying a backend version of the backend component associated with the version identifier in the request;
loading, into the cloud account, the backend component corresponding to the identified backend version;
executing the loaded backend component to process the request and generate the requested virtual reality content; and
returning the requested virtual reality content to the client device.

2. The method of claim 1, wherein the version identifier for the backend component is a component package version identifier for a component package of the backend component.

3. The method of claim 2, wherein identifying the backend version of the backend component associated with the version identifier comprises identifying a component package version for the component package of the backend component based on the component package version identifier.

4. The method of claim 3, wherein loading the backend component includes loading the component package corresponding to the identified component package version, the component package corresponding to the identified component package version comprising a backend function.

5. The method of claim 4, wherein executing the loaded backend component comprises executing the backend function.

6. The method of claim 1, wherein the backend version is not the latest backend version of the backend component.

7. The method of claim 1, further comprising:
receiving a second request for second virtual reality content from a second client device executing the client side component of the virtual reality software application, the request including a second version identifier for the backend component;
identifying a second backend version of the backend component associated with the second version identifier in the request, wherein the second backend version is different than the backend version;
loading, into the cloud account, the backend component corresponding to the second backend version in a serverless environment, wherein the backend component corresponding to the identified second backend version is different than the backend component corresponding to the identified backend version;
executing the backend component corresponding to the second backend version to process the second request and generate the second requested virtual reality content; and
returning the second requested virtual reality content to the second client device.

8. The method of claim 1, wherein the backend component is loaded in a serverless environment.

9. The method of claim 1, wherein each backend version of the backend component has a different application programming interface (API) protocol.

10. A non-transitory computer-readable storage medium storing instructions that, when executed by a computing device, cause the computing device to perform operations comprising:
provisioning an application-specific cloud account for a backend component of a virtual reality software application;
receiving a request for virtual reality content from a client device executing a client side component of the virtual reality software application, the request including authorization credentials and a version identifier for the backend component;
validating the authorization credentials to determine the client device is authorized to access the requested virtual reality content;
identifying a backend version of the backend component associated with the version identifier in the request;
loading, into the cloud account, the backend component corresponding to the identified backend version;
executing the loaded backend component to process the request and generate the requested virtual reality content; and
returning the requested virtual reality content to the client device.

11. The non-transitory computer-readable storage medium of claim 10, wherein the version identifier for the backend component is a component package version identifier for a component package of the backend component.

12. The non-transitory computer-readable storage medium of claim 11, wherein identifying the backend version of the backend component associated with the version identifier comprises identifying a component package version for the component package of the backend component based on the component package version identifier.

13. The non-transitory computer-readable storage medium of claim 12, wherein loading the backend component includes loading the component package corresponding to the identified component package version, the component package corresponding to the identified component package version comprising a backend function.

14. The non-transitory computer-readable storage medium of claim 13, wherein executing the loaded backend component comprises executing the backend function.

15. The non-transitory computer-readable storage medium of claim 10, wherein the backend version is not the latest backend version of the backend component.

16. The non-transitory computer-readable storage medium of claim 10, further comprising:
receiving a second request for second virtual reality content from a second client device executing the client side component of the virtual reality software application, the request including a second version identifier for the backend component;
identifying a second backend version of the backend component associated with the second version identifier in the request, wherein the second backend version is different than the backend version;
loading, into the cloud account, the backend component corresponding to the second backend version in a serverless environment, wherein the backend component corresponding to the identified second backend version is different than the backend component corresponding to the identified backend version;
executing the backend component corresponding to the second backend version to process the second request and generate the second requested virtual reality content; and
returning the second requested virtual reality content to the second client device.

17. The non-transitory computer-readable storage medium of claim 10, wherein the backend component is loaded in a serverless environment.

18. The non-transitory computer-readable storage medium of claim 10, wherein each backend version of the backend component has a different application programming interface (API) protocol.

19. A system comprising:
a set of one or more processors; and
a computer-readable storage medium storing instructions that, when executed by the set of one or more processors, cause the set of one or more processors to perform operations comprising:
provisioning an application-specific cloud account for a backend component of a virtual reality software application;
receiving a request for virtual reality content from a client device executing a client side component of the virtual reality software application, the request including authorization credentials and a version identifier for the backend component;
validating the authorization credentials to determine the client device is authorized to access the requested virtual reality content;
identifying a backend version of the backend component associated with the version identifier in the request;
loading, into the cloud account, the backend component corresponding to the identified backend version;
executing the loaded backend component to process the request and generate the requested virtual reality content; and
returning the requested virtual reality content to the client device.

20. The system of claim 19, wherein the version identifier for the backend component is a component package version identifier for a component package of the backend component.
